(19) United States
(12) Patent Application Publication
(10) Pub. No.: US 2016/0188687 A1
(43) Pub. Date: Jun. 30, 2016

(54) METADATA EXTRACTION, PROCESSING, AND LOADING

(71) Applicant: HEWLETT-PACKARD DEVELOPMENT COMPANY, L.P., Houston, TX (US)

(72) Inventor: Deepak Nair, Fremont, CA (US)

(21) Appl. No.: 14/907,861

(22) PCT Filed: Jul. 29, 2013
(86) PCT No.: PCT/US2013/052541

§ 371 Date: Jan. 27, 2016

(51) Int. Cl. G06F 17/30

(52) U.S. Cl. CPC G06F 17/30563; G06F 17/30592; G06F 17/30569

(57) ABSTRACT

Techniques for data storage are described herein. The techniques may include receiving data 302 having a plurality of the types. Metadata is identified 304 defining the plurality of file types. The techniques include dynamically allocating 306 one or more devices based on the metadata. The techniques include extracting 308 the data at a dynamically allocated device, the extraction based on the metadata, wherein extracting generates secondary metadata. The extracted data is processed 310 at a dynamically allocated device, the processing based on the metadata and secondary metadata. The processed data is loaded 312 from a dynamically allocated device into a data warehouse.

### BACKGROUND

In computing, storage system may be provided to individuals, enterprises, and the like. Metrics related to the storage system may be gathered. For instance, a storage system may be monitored for usage, performance, components, and types of operations being performed within the storage system.

### BRIEF DESCRIPTION OF DRAWINGS

Certain examples are described in the following detailed description and in reference to the drawings, in which:

FIG. 1 is a block diagram of a computing system configured to receive data and metadata;

FIG. 2 is a component diagram of a system of allocating data to devices to extract, process, and load data received into a data warehouse;

FIG. 3 is a block diagram illustrating a method of processing data to be loaded into a data warehouse; and

FIG. 4 is a block diagram depicting an example of a tangible, non-transitory computer-readable medium that can display pre-defined configuration of content elements.

### DETAILED DESCRIPTION

In data warehousing, a database is used for collecting data such as system metrics. An Extract, Transform, and Load (ETL) process may be useful in providing system metrics to a data warehouse, The warehoused system metrics may be useful in data analytics. In some cases, system metrics may be relatively large in size, of various formats, and from various systems, and may restrict the ability to perform an ETL process to load the system metrics into a data warehouse database.

The subject matter disclosed herein relates to an extract, transform, and load (ETL) system. Specifically, the techniques described herein include files tagged with metadata to extract, transform, and load the data. A system, implementing metadata in ETL processes may be horizontally and vertically scalable. For example, the system dynamically allocates devices in the system to perform a given ETL operations based, in part, on metadata received. Further, the system load-balances based on the capacity of the devices in the system. The load-balancing may be performed in view of metadata including the location of files in the system.

A “data warehouse,” as referred to herein, is a database configured to store data from a variety of sources in coherent format. The data warehouse may receive operational data indicating metrics associated with a remote storage system. The operational data may be split, reformatted, and loaded into the data warehouse.

“Metadata,” as referred to herein, is data at least partially defining a file type of files received, a definition of a file element, and a definition of a function to process the file elements. Metadata may be received as input from an operator, and secondary metadata may be generated as a result of the extraction and processing functions described below.

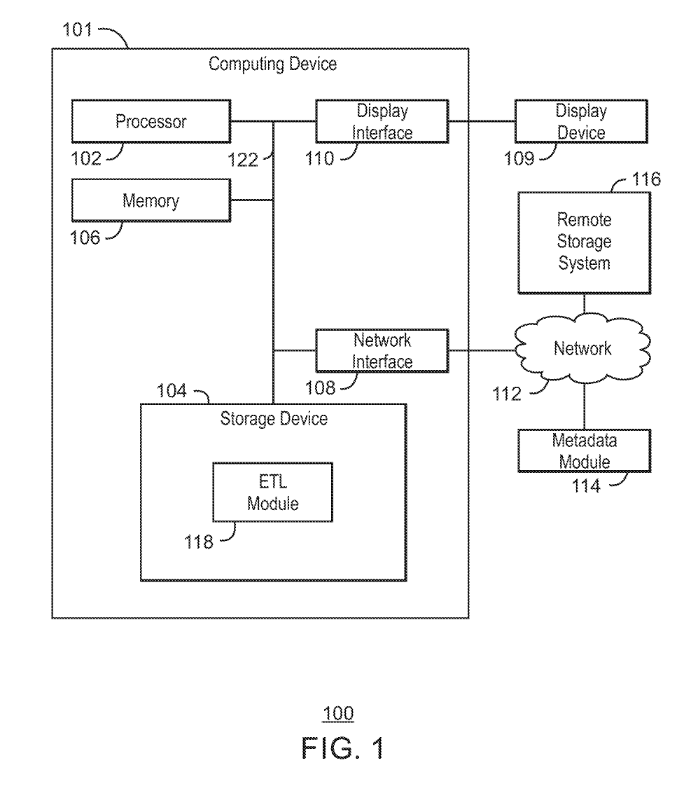

FIG. 1 is a block diagram of a computing system configured to receive data and metadata. The computing system 100 may include a computing device 101 having a processor 102, a storage device 104 having a non-transitory computer-readable medium, a memory device 106, a network interface 108, and a display interface 110. The computing device 101 may communicate, via the network interface 108, with a network 112 to access a remote metadata module 114.

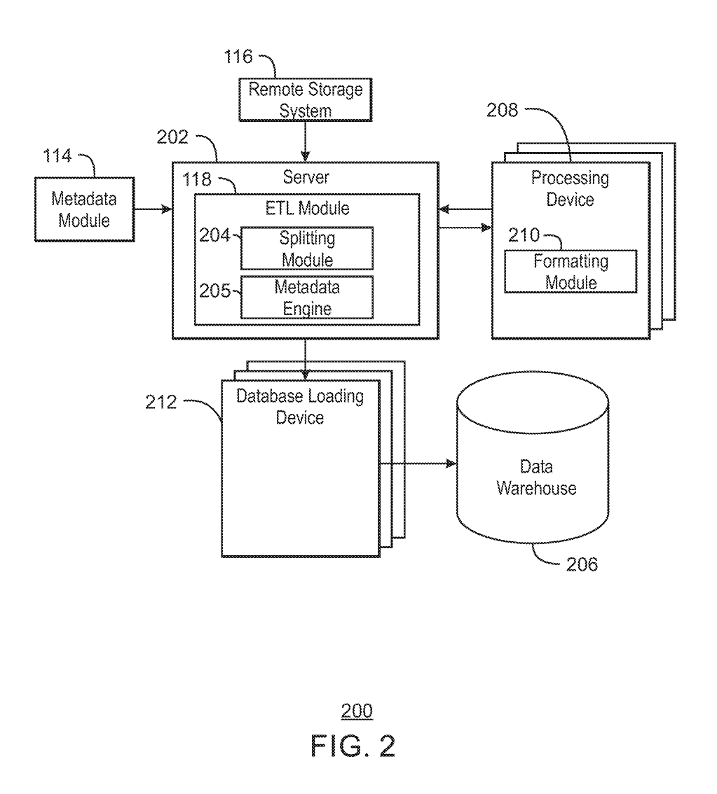

The storage device 104 may include an extract, transform and load (ETL) module 118. The ETL module 118 receives data from a remote storage system 116. The ETL module 118 may be a set of instructions stored on the storage device 104. The instructions, when executed by the processor 102, direct the computing device 101 to perform operations including receiving data having a plurality of file types and identifying metadata defining the plurality of file types. The instructions may direct the computing device 101 to dynamically allocate a device to extract, process, or load, based on the metadata, In embodiments, the instructions direct the computing device 100 to extract the data based on the metadata, wherein extracting generates secondary metadata, and processing the extracted data based on the metadata and secondary metadata. The extraction and processing may be performed by devices, such as virtual machines described in more detail below. In general, the processed data may be loaded into a data warehouse as discussed in more detail below in reference to FIG. 2.

The processor 102 may be a main processor that is adapted to execute the stored instructions, The processor 102 may be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU).

The memory device 106 can include random access memory (RAM) (e.g., static RAM, dynamic RAM, zero capacitor RAM, Silicon-Oxide-Nitride-Oxide-Silicon, embedded dynamic RAM, extended data out RAM, double data rate RAM, resistive RAM, parameter RAM, etc.), read only memory (ROM) (e.g., Mask ROM, parameter ROM, erasable programmable ROM, electrically erasable programmable ROM, etc.), flash memory, or any other suitable memory systems. The main processor 102 may be connected through a system bus 124 (e.g., RCI, ISA, PCI-Express, etc.) to the network interface 108. The network interface 108 may enable the computing device 101 to communicate, via the network 114, with the remote devices 116.

The block diagram of FIG. 1 is not intended to indicate that the computing device 101 is to include all of the components shown in FIG. 1. Further, the computing device 101 may include any number of additional components not shown in FIG. 1, depending on the details of the specific implementation.

FIG. 2 is a component diagram of a system of allocating data to devices to extract, process, and load data received into a data warehouse. The system 200 includes an operational database server (ODS) 202 configured to receive files from a remote storage system, such as the remote storage system 116 of FIG. 1, and metadata from the metadata module, such as the metadata module 114. The ODS 202 may be a computing device, such as the computing device 101 discussed above in reference to FIG. 1. In embodiments, the metadata module 114 may be an internet-based module wherein an operator of the system 200 may indicate metadata including file types to be received from the remote storage system 116. The metadata may include additional elements including a definition for a file element, wherein each file type includes a plurality of file elements, and a definition of a function to process the file elements.

The ODS 202 may split the files at a splitting module 204. The files are split based on the metadata received from the metadata module 114. For example, the metadata may indicate incoming files are one of four file types: a configuration file, a performance file, a hardware inventory file, and an alert file. The splitting module 204 may split the incoming files according to their file type. The splitting may generate secondary metadata indicating the types of files that have been split, a location of the files, and a function to process the files based on file elements. In embodiments, the secondary metadata may be generated via a metadata engine 205. The function includes instructions of how to modify the files according to the file elements such that the files may be coherent with a format of a data warehouse 210. The split files, the metadata, and the secondary metadata, are provided to one of a plurality of processing devices 208. The processing devices 208 may process the files received based on the metadata, including the file type, and based on the secondary metadata, including reformatting of the data in the files by a formatting module 210.

Processed files may be provided back to the ODS 202 and ultimately to database loading devices 212 prior to loading into the data warehouse. In embodiments, the devices, such as the processing devices 208 and the database loading devices 212 are virtual machines. The virtual machines may be configured to run on the ODS 202, or on a remote computing device (not shown). In embodiments, a processing device 208 may be allocated as a database loading device 212 based on metadata received. For example, the operator of the system 200 may indicate that one or more of the processing devices 210 be allocated as database loading devices 212. Similarly, a database loading device 212 may be allocated by the metadata as a processing device 210. The flexibility of the system 200 enables the system 200 to be configured dynamically based on the number of files received, the type of files received, and the like.

In embodiments, the system 200 may load balance the database loading devices 212 or the processing devices 208. For example, incoming files may be split by the splitting module 204, and distributed equally to the processing devices 208. The system 200 may monitor the progress of the processing devices 208 including a backlog of files to be processed. The system 200 may reallocate files to a different processing device 208 configured to process a given file element associated with the backlogged data. Thus, the system 200 may load-balance across the processing devices 208 based on available processing capability of a given processing device in view of the processing capability of another processing device.

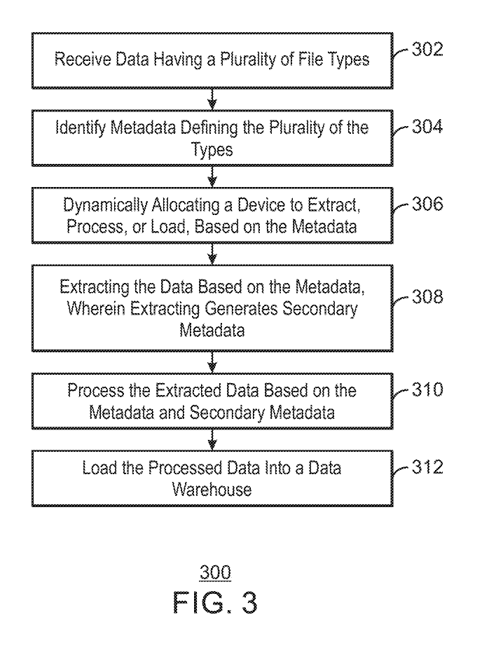

FIG. 3 is a block diagram illustrating a method of processing data to be loaded into a data warehouse. The method 300 includes receiving, at block 302, data having a plurality of file types, and identifying, at block 304, metadata defining the plurality of file types. The metadata may be received from a metadata module. In embodiments, the metadata is entered by an operator of a system using the method such as the system 200 discussed above in reference to FIG. 2.

At block 306, devices are allocated based on the metadata. A plurality of devices may be allocated and may include one or more virtual machines configured to either process or load the data. The allocation is based on the metadata received. For example, the metadata may indicate that out of 10 virtual machines, 4 are processing devices, and 6 are loading devices. At block 308, the data is extracted based on the metadata. The extraction at block 308 includes splitting the data based on the metadata based on metadata indicating a file type. The extraction may generate secondary metadata including instructions on how to format file elements of each file type at the processing devices.

At block 310, the extracted data is processed based on the metadata and the secondary metadata. At block 312, the processed data is loaded into a data warehouse.

In embodiments, the method 300 includes load balancing. For example, the method 300 may allocate, in view of the metadata and the secondary metadata, the data to the plurality of processing devices based on an available processing capability of each device. As another example, the method 300 may allocate the processed data to the plurality of loading devices based on an available processing capability of each loading device.

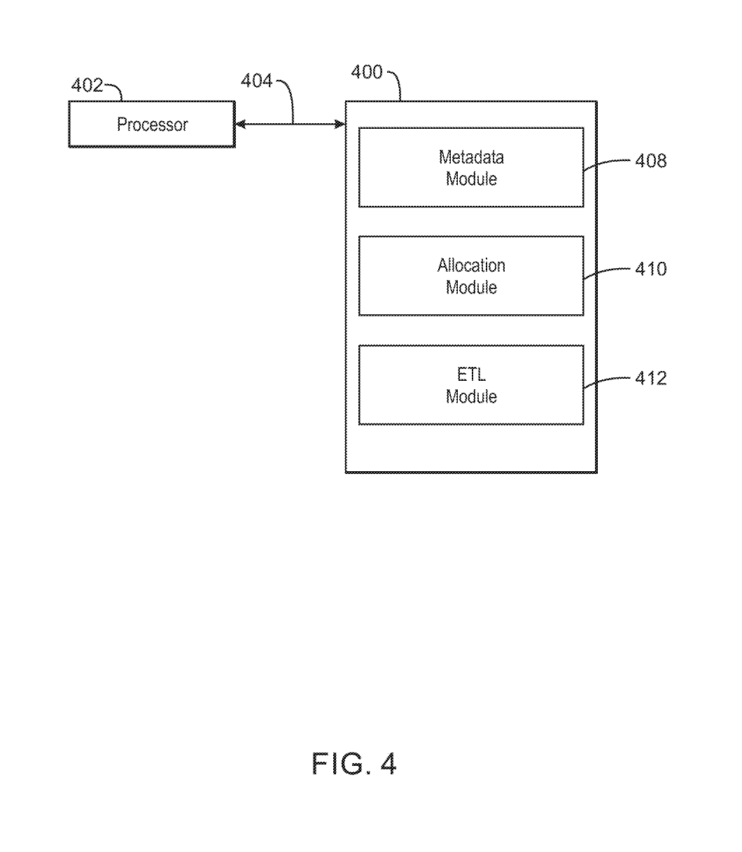

FIG. 4 is a block diagram depicting an example of a tangible, non-transitory computer-readable medium that can display pre-defined configuration of content elements. The tangible, non-transitory, computer-readable medium 400 may be accessed by a processor 402 over a computer bus 404. Furthermore, the tangible, non-transitory, computer-readable medium 400 may include computer-executable instructions to direct the processor 402 to perform the steps of the current method.

The various software components discussed herein may be stored on the tangible, non-transitory, computer-readable medium 400, as indicated in FIG. 4. For example, a metadata module 408 can provide metadata to an allocation module 410. The metadata may be received from an operator of a system using the computer-readable medium 400. An ETL module 412 may be configured to extract, process, and load files received from a remote storage system based on the metadata received at the metadata module. Although the components of the computer-readable media 400 are represented as being disposed on a single media, each module may be disposed on remote computer-readable medium including tangible computer-readable media.

The present examples may be susceptible to various modifications and alternative forms and have been shown only for illustrative purposes. Furthermore, it is to be understood that the present techniques are not intended to be limited to the particular examples disclosed herein. Indeed, the scope of the appended claims is deemed to include all alternatives, modifications, and equivalents that are apparent to persons skilled in the art to which the disclosed subject matter pertains.

What is claimed is:

1. A method comprising:
receiving data having a plurality of file types;
identifying metadata defining the plurality of file types;
dynamically allocating one or more devices based on the metadata;
extracting the data at a dynamically allocated device, the extraction based on the metadata, wherein extracting generates secondary metadata;
processing the extracted data at a dynamically allocated device, the processing based on the metadata and secondary metadata; and
loading the processed data from a dynamically allocated device into a data warehouse.

2. The method of claim 1, comprising receiving the metadata from a metadata module, the metadata input by an operator comprising;
a definition for a file type;
a definition for a file element, wherein each file type comprises a plurality of file elements; and
a definition of a function to process the file elements.

3. The method of claim 1, wherein extracting the data comprises splitting the data based on the metadata to be processed or loaded at one of a plurality of devices.

4. The method of claim 1, wherein the processing comprises formatting the data to be coherent with a format of the data warehouse.

5. The method of claim 1, wherein the extracting is performed at an extraction device and the processing is performed at a plurality of processing devices, the method comprising allocating, in view of the metadata and the secondary metadata, the data to the plurality of processing devices based on an available processing capability of each processing device.

6. The method of claim 1, wherein the loading is performed at a plurality of loading devices, the method comprising allocating the processed data to the plurality of loading devices based on an available processing capability of each loading device.

7. The method of claim 1, wherein the metadata indicates a number of devices to be allocated to processing the data and a number of devices to be allocated to loading the data.

8. A system comprising:
a processing device to receive data having a plurality of file types; and
a system memory, wherein the system memory comprises computer-executable instructions to direct the processing device to:
identify metadata defining the plurality of file types;
dynamically allocate one or more devices based on the metadata;
extract the data at a dynamically allocated device, the extraction based on the metadata, wherein extracting generates secondary metadata;
process the extracted data at a dynamically allocated device, the processing based on the metadata and secondary metadata; and
load the processed data from a dynamically allocated device into a data warehouse.

9. The system of claim 7, further comprising computer-executable instructions to direct the processing device to receive the metadata from a metadata module, the metadata input by an operator comprising:
a definition for a tile type;
a definition for a file element, wherein each tile type comprises a plurality of file elements;
a definition of a function to process the file elements.

10. The system of claim 7, wherein to extract the data comprises to split the data based on the metadata to be processed at one of a plurality of devices.

11. The system of claim 7, wherein to process comprises to format the data to be coherent with a format of the data warehouse.

12. The system of claim 7, wherein the extraction is to be performed at an extraction device and the processing is to be performed at a plurality of processing devices, wherein the computer-executable instructions to direct the processing device allocate, in view of the metadata and the secondary metadata, the data to the plurality of processing devices based on an available processing capability of each processing device.

13. The system of claim 7, wherein to loading is to be performed at a plurality of loading devices, wherein to allocate the formatted data to the plurality of loading devices is based on an available processing capability of each loading device.

14. A non-transitory, tangible, computer-readable storage medium, comprising computer-executable instructions configured to direct a processing unit to:
receive data having a plurality of file types;
identify metadata defining the plurality of file types;
dynamically allocate one or more devices based on the metadata;
extract the data at a dynamically allocated device, the extraction based on the metadata, wherein extracting generates secondary metadata;
process the extracted data at a dynamically allocated device, the processing based on the metadata and secondary metadata; and
load the processed data from a dynamically allocated device into a data warehouse.

15. The computer-readable storage medium of claim 14, comprising computer-executable instructions configured to direct a processing unit to receive the metadata from a metadata module, the metadata input by an operator comprising:
a definition for a file type;
a definition for a the element, wherein each the type comprises a plurality of the elements; and
a definition of a function to process the file elements.
